(19) United States
(12) Patent Application Publication
(10) Pub. No.: US 2017/0161828 A1
(43) Pub. Date: Jun. 8, 2017

(54) SYSTEM, INFORMATION PROCESSING DEVICE, INFORMATION PROCESSING METHOD AND COMPUTER READABLE RECORDING MEDIUM

(71) Applicant: NS SOLUTIONS CORPORATION, Tokyo (JP)

(72) Inventors: Hitoshi MINAMI, Tokyo (JP); Yusuke KATO, Fukuoka-shi (JP)

(21) Appl. No.: 15/346,243

(22) Filed: Nov. 8, 2016

(30) Foreign Application Priority Data
Dec. 7, 2015 (JP) 2015-238804

(51) Int. Cl. G06Q 40/04

(52) U.S. Cl. CPC G06Q 40/04

(57) ABSTRACT

A system has an obtaining unit obtaining a trade index of a currency pair on a set due date, an interpolation unit interpolating trade indexes of a first day and a last day of a trade period in the time option trade based on the trade index obtained by the obtaining unit, and a determining unit determining an interest rate structure of the trade period based on the trade indexes of the first day and the last day of the trade period interpolated by the interpolation unit.

### CROSS-REFERENCE TO RELATED APPLICATIONS

This application is based upon and claims the benefit of priority of the prior Japanese Patent Application No. 2015-238804, filed on Dec. 7, 2015, the entire contents of which are incorporated herein by reference.

### BACKGROUND OF THE INVENTION

Field of the Invention

The present invention relates to a system, an information processing device, an information processing method and a computer readable recording medium.

Description of the Related Art

In late years, foreign exchange trade systems using the Internet are spreading. Foreign exchange trade is a financial trade made by, for example, a company that makes an export or import trade by deciding in advance an exchange rate to be applied when a certain currency is received or paid at a certain time in the future, so as to reduce a currency risk that occurs due to a difference in exchange market prices between the time when a contract is closed and the time when a payment is made. Patent Documents 1 and 2 describe technologies supporting foreign exchange trades.

### (Regarding Time Option Trade)

Among foreign exchange trades, a trade that promises an execution of an exchange trade on a specific due date in the future is called a spot or outright forward trade, and a trade that promises an execution of an exchange trade during a certain period in the future is called a time option trade. The time option trade is used, for example, when a specific day cannot be decided as the payment period of a price in foreign currency which is received or paid by an export or import company, or when a delay of an arrival of payment or a situation that a payment or the like is made in advance is anticipated. In this time option trade, a constant exchange rate is applied when payment takes place in the specific trade period. For example, when a foreign exchange trade (time option trade) with a trade period of August 20 to September 20 is conducted on a certain day of July, and if payment in foreign currency occurs on August 20, August 30, September 10, or September 20, the payment will be conducted at the same rate on any of the dates.

### (Regarding a Tradable Price)

A tradable price in the foreign exchange trade is determined based on the interest rate difference between a tradable price (value today price, an exchange rate when a trade will be made in two business days from the date of a foreign exchange trade) and the trading currency when the foreign exchange trade is made. The interest rate of the trading currency is determined everyday in the interbank market.

The interbank market means trading among banks or a market for trading among banks. Trading may be executed directly between banks, or besides such cases, trading may also be executed between banks via a broker.

The interest rate among banks in the Tokyo market in Japan is called TIBOR (Tokyo InterBank Offered Rate). From respective rates offered by banks to the Japanese Bank Association, the TIBOR is calculated by excluding values of higher-order two banks and lower-order two banks from the respective rates offered by the banks, and simply averaging other offered rates, and 13 rates of one-week rate and 1-month to 12-month rates are published.

Here, a forward price will be explained in an example of the foreign exchange trade to exchange the dollar and the yen in a year. It is assumed that the tradable price (spot price) at the timing to make the foreign exchange trade is one dollar=120 yen, the one-year interest rate of the Japanese yen is 1%, and the one-year interest rate of the U.S. dollar is 5%. The forward price is determined so that the operation amount becomes equal regardless of whether it is operated in the yen or the dollar. Specifically, it is expressed by following expression (1).

Principal (yen)×(1+yen interest rate×day/365)=principal (dollar)×(1+dollar interest rate×day/360) (expression 1)

Therefore, the forward price of a foreign exchange trade (forward trade) to exchange the dollar and the yen in a year is expressed by following expression (2).

(dollar)=120 (yen)×(1+0.01×365/365)/(1+0.05×360/360)=115.43 yen (expression 2)

That is, the forward price is determined as a price calculated by adding or subtracting the difference of an interest-equivalent price obtained when respective currencies are operated until the due date of payment to or from the spot price at the timing the foreign exchange trade is to be executed. The difference between a spot price and a forward price is called a spread. Note that the spread may also be called a swap point or a swap rate, or the like.

### (Regarding Interest Rate Structure)

An interest rate structure is information indicating how the exchange rate of a currency pair fluctuates due to the difference in the interest rates of respective currencies of the currency pair in a certain period.

In the above-described example of the foreign exchange trade to exchange the dollar and the yen in a year, since the interest rate in the United States is higher than in Japan, the tradable price (1 dollar=115.43 yen) becomes stronger in the yen against the dollar from the spot price (1 dollar=120 yen) at the timing the foreign exchange trade is executed. Such an interest rate structure is called dollar discount/yen premium.

On the other hand, when the foreign exchange trade is executed when the interest rate is higher in Japan than in the United States, the forward price becomes weaker in the yen against the dollar from the spot price. Such an interest rate structure is called dollar premium/yen discount.

Regarding the tradable price between the dollar and the yen, the price is presented based on the dollar which is the base currency so as to indicate how much one dollar is in the yen. Hereinafter, the interest rate structure when the currency on the reference side is discount will simply be called discount, and the interest rate structure when the currency on the reference side is premium will simply be called premium.

Patent Document 1: Japanese Laid-open Patent Publication No. 2012-27516

Patent Document 2: Japanese Laid-open Patent Publication No. 2002-207880

When the foreign exchange trade of the time option trade is made, the exchange will be executed at a certain rate in the trade period. In this case, the bank side would conceivably like to perform the foreign exchange trade at a favorable rate as much as possible. For example, it is assumed that the bank makes a foreign exchange trade to sell the dollar (or customer buys the dollar) when the trade period of the time option trade is determined as August 20 to September 20 on a certain day in July of the interest rate structure of dollar discount. Here, it is assumed that the forward price on August 20 is 120 yen/dollar, and the forward price on September 20 is 119.8 yen/dollar. The forward price weakens in the dollar over the period, and thus it is desired that as the rate for the bank to sell the dollar in the trade period in this case, it is desired to set a rate as closer as possible to the rate of the first day of the period.

Therefore, a foreign exchange trade dealer of the bank needs to determine the forward price by determining whether the interest rate structure in the trade period is discount or premium by checking the interest rates in the two countries of the currency pair, or the like based on the rate on either the first day or the last day of the trade period. On the other hand, the spot price always fluctuates, and thus the dealer needs to quickly determine the forward price used in the time option trade.

However, as described above, the interest rates include not only one type of interest rate but many discrete interest rates, such as one-month rate to 12-month rate. Thus, the dealer checks these many discrete interest rates and/or the like every time there is an inquiry about the foreign exchange trade of the time option trade in two countries of the currency pair, so as to determine the interest rate structure of the trade period. However, since the values of checkable interest rates and/or the like are discrete, it has not been easy for the dealer to determine an accurate interest rate structure in the trade period. Thus, the dealer anticipates the interest rate structure in the trade period from the values of the discrete interest rates or the like. However, the anticipation takes time and causes a delay from when a rate inquiry is requested from a customer until an offer is made. Hence it has not been possible to offer an appropriate tradable price according to the spot rate, or it has been possible to make a mistake in determination of the interest rate structure. Thus, there is a problem that the forward price cannot be determined quickly. Conventional arts have not solved this problem.

### SUMMARY OF THE INVENTION

Accordingly, it is an object of the present invention to determine the forward price quickly.

A system of the present invention has an obtaining unit obtaining a trade index of a currency pair on a set due date, an interpolation unit interpolating trade indexes of a first day and a last day of a trade period in the time option trade based on the trade index obtained by the obtaining unit, and a determining unit determining an interest rate structure of the trade period based on the trade indexes of the first day and the last day of the trade period interpolated by the interpolation unit.

### BRIEF DESCRIPTION OF THE DRAWINGS

FIG. 1 is a diagram illustrating an example of a system configuration of an information processing system;

FIG. 2 is a diagram illustrating an example of the hardware configuration of a management server;

FIG. 3 is a diagram illustrating an example of a functional configuration of the management server;

FIG. 4 is a sequence diagram illustrating an example of processing of the information processing system;

FIG. 5A is a view illustrating an example of an inquiry screen;

FIG. 5B is a view illustrating an example of the inquiry screen;

FIG. 5C is a view illustrating an example of the inquiry screen;

FIG. 6 is a diagram illustrating an example of trade detail information;

FIG. 7 is a view illustrating an example of a tradable price offering screen;

FIG. 8 is a flowchart illustrating an example of tradable price calculating processing;

FIG. 9 is a diagram illustrating a spread on a specific due date;

FIG. 10 is a graph explaining interpolation processing;

FIG. 11 is a diagram illustrating a correspondence between an interest rate structure and a due date used for tradable price calculation;

FIG. 12A is a diagram explaining a time option trade;

FIG. 12B is a diagram explaining a time option trade;

FIG. 13 is a flowchart illustrating an example of the tradable price calculating processing in consideration of cash management;

FIG. 14 is a diagram illustrating a correspondence between an interest rate structure and a forward price used for tradable price calculation in consideration of cash management; and

FIG. 15 is a diagram illustrating interest rate information on a specific due date.

### DETAILED DESCRIPTION OF THE PREFERRED EMBODIMENTS

### Embodiment 1

Hereinafter, an embodiment of the present invention will be described based on drawings.

### (System Configuration of an Information Processing System)

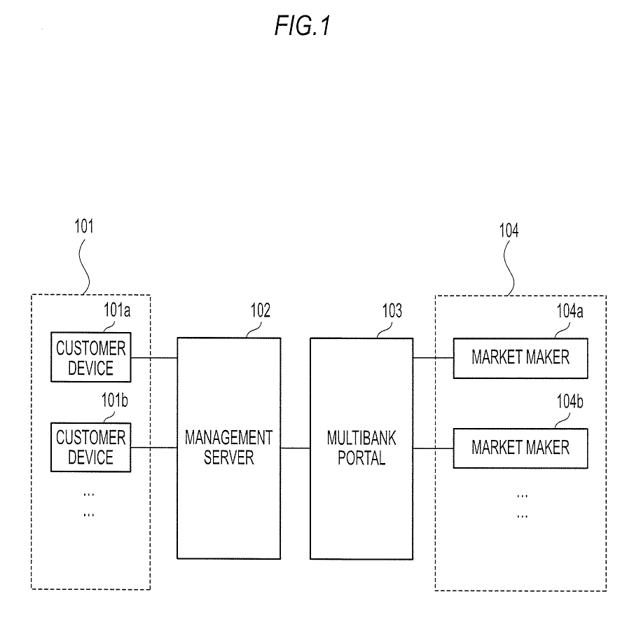

FIG. 1 is a diagram illustrating an example of a system configuration of an information processing system of this embodiment. In this embodiment, it is assumed that a bank makes a buying and selling trade of a currency, which is a time option trade, with a customer via the information processing system.

The information processing system includes a customer device 101, a management server 102, a multibank portal 103, and a market maker device 104. The management server 102 is connected to the customer device 101 and the multibank portal 103 via a network. Further, the multibank portal 103 is connected to a market maker device 104 via a network.

The customer device 101 is an information processing device of a customer's PC (personal computer), server device, and/or the like connected to the network. Here, the customer device of customer A and the customer device of customer B are called a customer device 101a and a customer device 101b, respectively, and these customer devices are collectively called a customer device 101. The number of customer devices 101 connected to the management server 102 may be one or plural.

The management server 102 is a server device which provides the function of the information processing system. By the management server 102 executing processing while managing processing of the information processing system, services and so on related to a foreign exchange trade are provided. In this embodiment, the management server 102 is a single server device, but may also be a cloud system including a plurality of server devices and/or an information processing device such as a PC. The cloud system is a system which includes a plurality of information processing systems connected via a network, and can provide various functions by these information processing devices performing processing in cooperation with each another.

The multibank portal 103 is constituted of a single server or a plurality of server devices, and/or the like, and mediate between the management server 102 and a plurality of market maker devices 104 in exchange of information.

The market maker device 104 is an information processing device such as a PC or a server device connected to a network of a market maker. Here, a market maker device in a market maker A and a market maker device in a market maker B are called a market maker device 104a and a market maker device 104b, respectively, and they are collectively called a market maker device 104. In this embodiment, the plurality of market maker devices 104 are connected to the multibank portal 103.

The management server 102 obtains information of an tradable price of foreign exchange (hereinafter simply referred to as foreign exchange) from the market maker device 104 via the multibank portal 103, and offers the obtained information of the tradable price to the customer device 101. Then, upon receiving the trade detail information or the like related to a trade detail of a time option trade from the customer device 101, the management server 102 calculates a tradable price which is an exchange rate used in the time option trade.

The tradable price is an execution price (market price) determined in the interbank market based on foreign exchange trades and the like in the interbank market.

(Hardware Configuration of the Management Server)

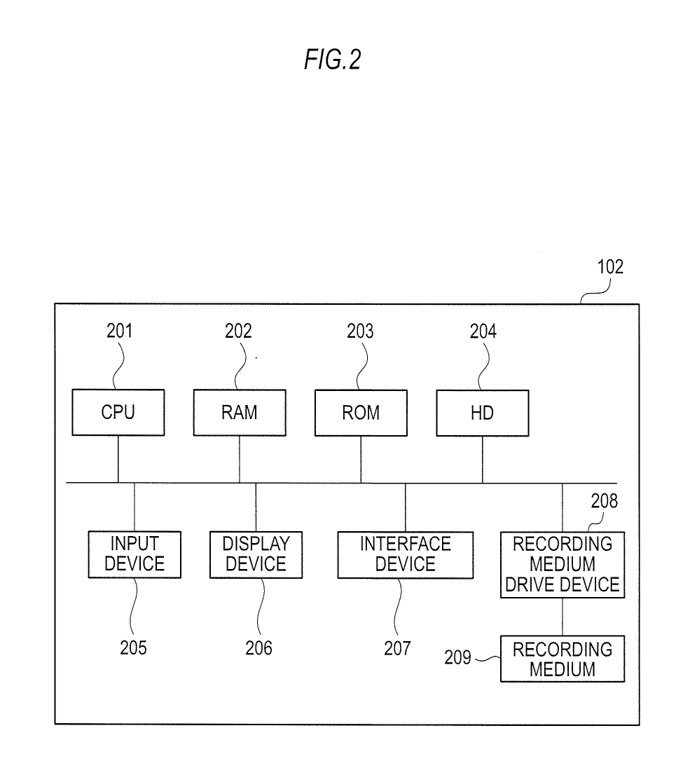

FIG. 2 is a diagram illustrating an example of the hardware configuration of the management server 102. When the management server 102 is a cloud system, each of the plurality of information processing devices included in the management server 102 has a hardware configuration similar to FIG. 2.

The management server 102 includes a CPU (Central Processing Unit) 201, a RAM (Random Access Memory) 202, and a ROM (Ready Only Memory) 203. Further, the management server 102 includes an HD (Hard Disk) 204, an input device 205, a display device 206, an interface device 207, and a recording medium drive device 208.

The CPU 201 is a central processing device controlling processing of the management server 102. The RAM 202 is a main memory of the management server 102. The ROM 203 is a storage device which stores a program and so on read first when the management server 102 is powered on. The HD 204 is a storage device which stores various programs and various data including data of thresholds required in processing executed by the CPU 201, and the like.

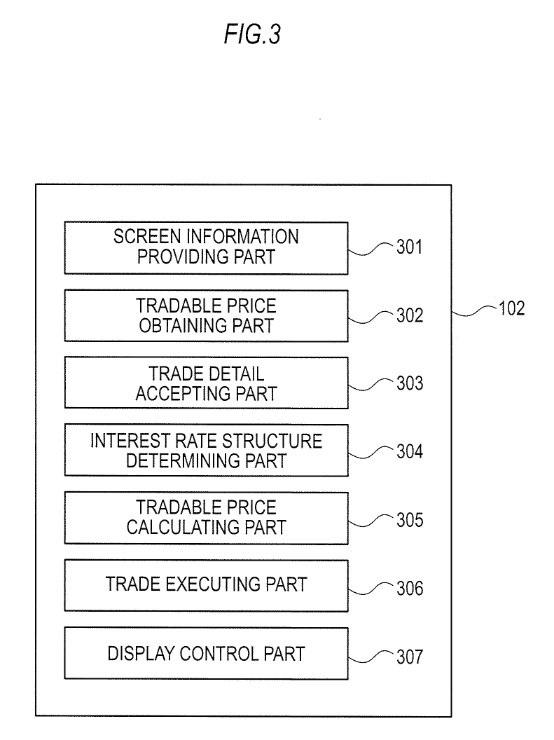

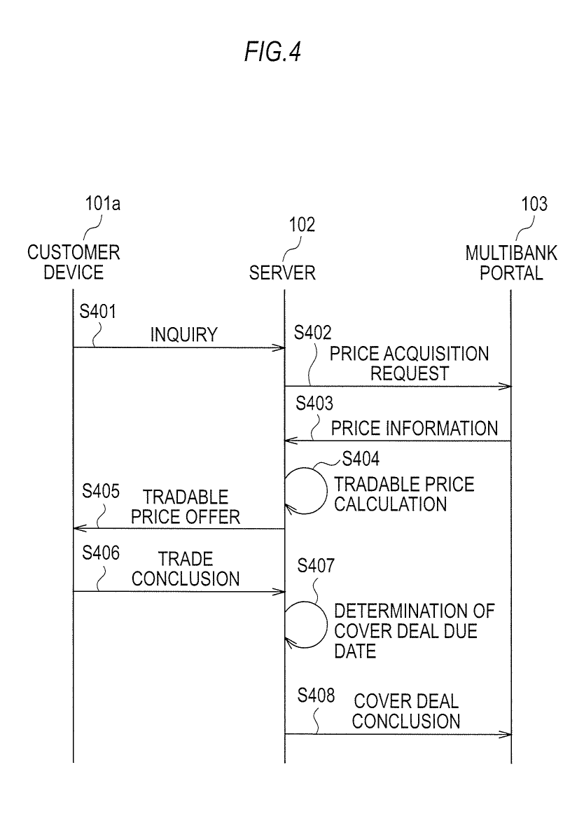

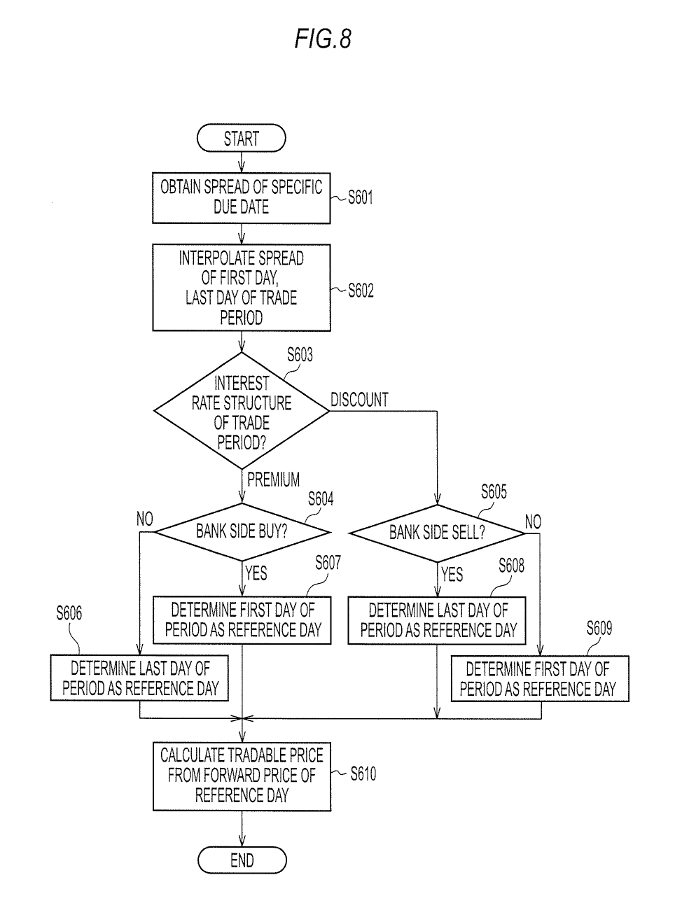

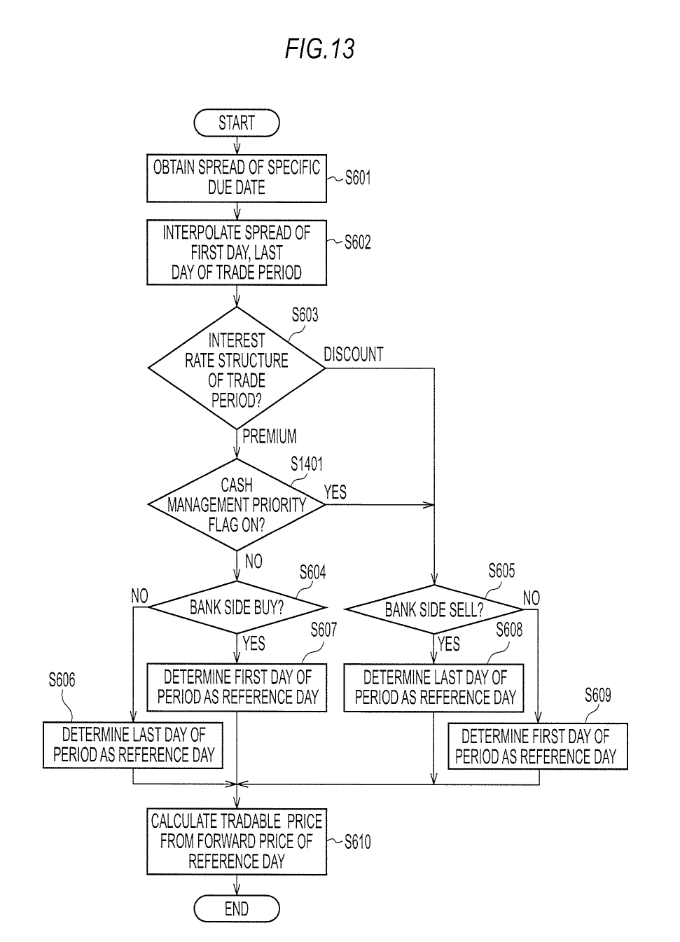

The CPU 201 executes processing based on a program stored in the ROM 203 or the HD 204, to thereby implement the following function and processing. That is, the function of the management server 102 which will be described later with FIG. 3, the processing of the management server 102 in a sequence diagram which will be described later with FIG. 4, and the processing of a flowchart which will be described later with FIG. 8 and FIG. 13.

When the management server 102 is a cloud system, the respective CPUs of the plurality of information processing devices included in the management server 102 execute processing in cooperation with each other based on programs stored in the respective ROMs or HDs of the plurality of information processing devices, to thereby implement the following function and processing. That is, the function of the management server 102 which will be described later with FIG. 3, the processing of the management server 102 in the sequence diagram which will be described later with FIG. 4, and the processing of the flowchart which will be described later with FIG. 8 and FIG. 13 are implemented.

The input device 205 is constituted of a keyboard and a mouse or the like operated by a manager or the like of the management server 102, and is used for inputting various operating information or the like in the management server 102. The display device 206 is constituted of a display or the like and displays various pieces of information or a screen and/or the like. Note that the display device 206 is a touch panel or the like capable of being operated by touching the display.

The interface device 207 is an interface connecting the management server 102 to a network and/or the like. The management server 102 obtains a program related to the function of the management server 102 from, for example, a recording medium 209, such as a CD-ROM, via the recording medium drive device 208 or by downloading from an external device via a network or the like. The management server 102 obtains a program recorded in the recording medium 209 via the recording medium drive device 208, and installs the program in the HD 204.

The hardware configuration of the customer device 101, the information processing device in the multibank portal 103, and the market maker device 104 is similar to the configuration illustrated in FIG. 2.

The CPU of the customer device 101 executes processing based on a program stored in the ROM or the hard disk drive of the customer device, to thereby implement the function of the customer device 101 and the processing of the customer device 101.

The CPU of the information processing device in the multibank portal 103 executes processing based on a program stored in the ROM or the hard disk drive of this information processing device, to thereby implement the function of the information processing device and the processing of the information processing device.

The CPU of the market maker device 104 executes processing based on a program stored in the ROM or the hard disk drive of the market maker device 104, to thereby implement the function of the market maker device 104 and the processing of the market maker device 104.

(The Functional Configuration of the Management Server)

FIG. 3 is a diagram illustrating an example of a functional configuration of the management server 102.

A screen information providing part 301 transmits to the customer device 101 screen information for displaying a screen offering various information to a customer. The transmitted screen information, for example, may be information for displaying a homepage screen or may be configuration information of screen necessary for displaying a screen. Thus, the customer may perform an operation related to a foreign exchange trade while confirming a displayed screen based on screen information received by the customer device 101 from the screen information providing part 301.

An tradable price obtaining part 302 obtains an tradable price from the market maker device 104 via the multibank portal 103 in response to the request from the customer device 101. The tradable price obtaining part 302 may obtain the tradable price from any market maker device included in the market maker device 104.

The trade detail accepting part 303 accepts trade detail information of an inputted foreign exchange trade based on an operation by the customer via an input screen for foreign exchange trade displayed on the display device 206 of the customer device 101 based on screen information transmitted by the screen information providing part 301 to the customer device 101. The trade detail information is information indicating trade detail such as a trading currency and a trade amount. Details of the trade detail information will be described later in FIG. 4.

An interest rate structure determining part 304 performs, when the trade detail information of time option trade is received from the customer device 101 by the trade detail accepting part 303, the following processing based on the received trade detail information and the tradable price obtained by the tradable price obtaining part 302. That is, the interest rate structure determining part 304 determines the interest rate structure of a trade period with respect to the time option trade to be executed.

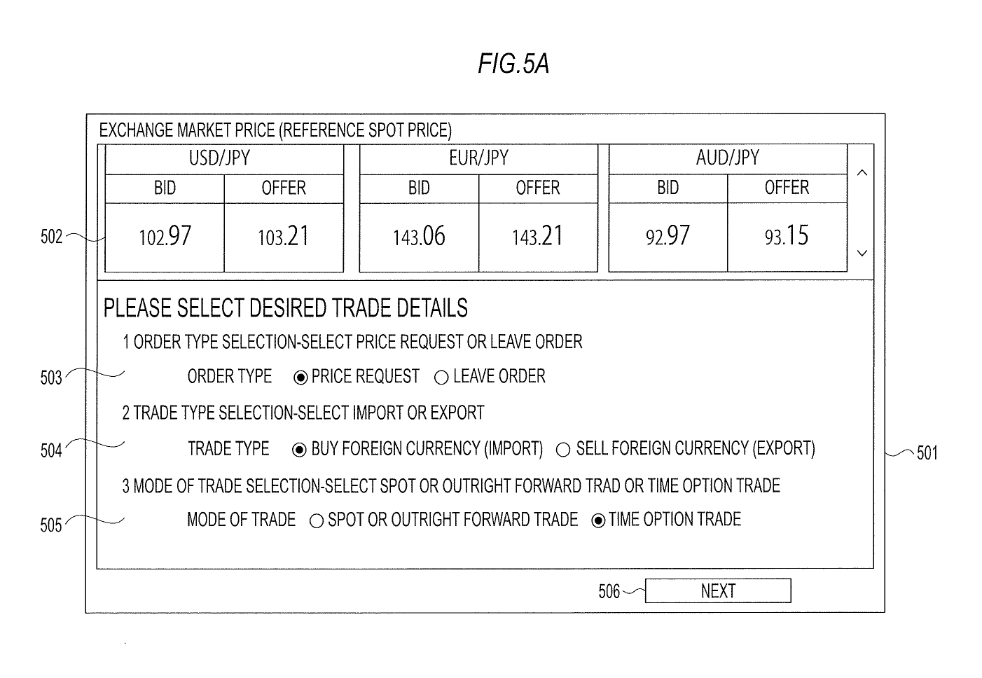

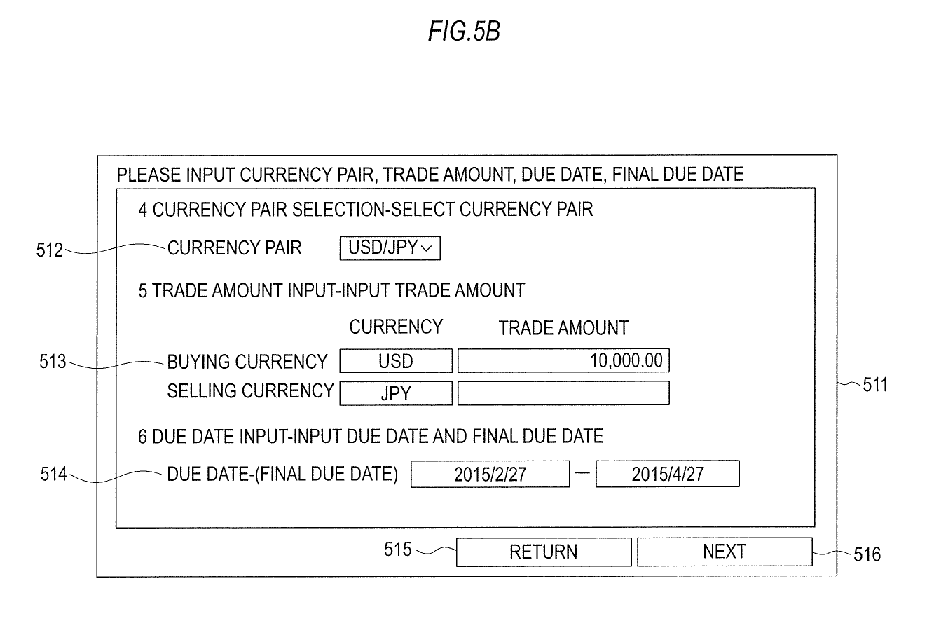

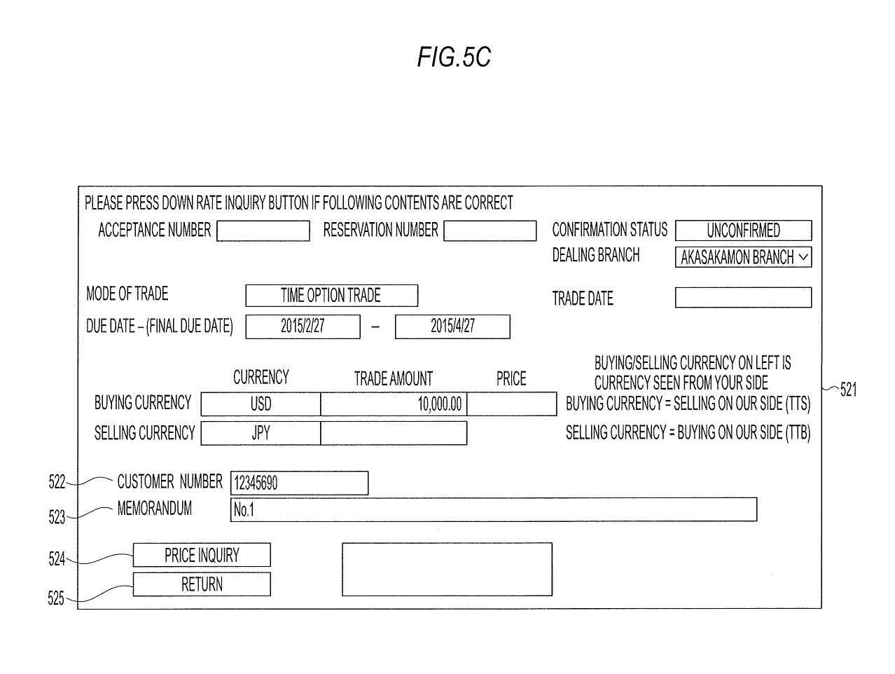

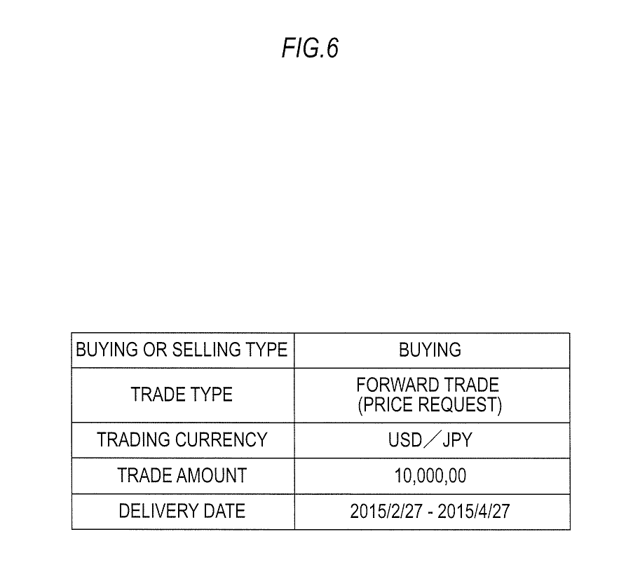

The tradable price calculating part 305 calculates a tradable price which is the exchange rate used for the time option trade performed with a customer based on the interest rate structure of the tradable period with respect to the time option trade determined by the interest rate structure determining part 304 and the forward price in this trade period. Details of the interest rate structure determining part 304 and the processing of the tradable price calculating part 305 will be described later in FIG. 5A, FIG. 5B, FIG. 5C, and FIG. 6C.

The screen information providing part 301 transmits to the customer device 101 the screen information for displaying a screen offering the tradable price calculated by the tradable price calculating part 305 to the customer. Thus, without requiring determination of the interest rate structure of a tradable period by a dealer or the like, the management server 102 is able to quickly and accurately calculate the tradable price used in the time option trade, and offer the calculated tradable price to the customer. Consequently, it is easy for the foreign exchange trade between the bank and the customer to be closed.

A foreign exchange trade executing part 306 stores, when the foreign exchange trade is closed with the tradable price calculated by the tradable price calculating part 305, the closed foreign exchange trade in an HD 204 of the management server 102, and transmits this information to the customer device 101 of the counterparty.

A display control part 307 displays various pieces of information related to the foreign exchange trade on the display device 206 of the management server 102.

(The Flow of Processing of the Time Option Trade)

FIG. 4 is a sequence diagram illustrating an example of processing of the information processing system of this embodiment. The flow of processing with respect to the time option trade in this embodiment will be explained by using FIG. 4. In this embodiment, it is a customer A who makes the time option trade with a bank, and the customer A operates the customer device 101a. In this embodiment, the customer A is a person. However, the customer A may be a corporation. In this case, an employee or the like of the customer A as the corporation operates the customer device 101a.

Further, in this embodiment, the trade exchanged between the customer A and the bank is a time option trade with a specific period from Feb. 27, 2015 to Apr. 27, 2015, and the foreign exchange trade is made on Feb. 23, 2015.

Further, in this embodiment, processing in which the information processing system uses a spread of a currency pair as a trading currency index will be explained. The trading currency index is information which can be used as an index when a trading currency is made. Examples of the trading currency index include the spread of a currency pair, the forward price of a currency pair, the interest rate difference of a currency pair, and/or the like.

In S401, the CPU of the customer device 101a makes an inquiry about a tradable price under trade detail of a specified time option trade to the management server 102 based on an operation by the customer A via an input screen, an operating part, or the like of the foreign exchange trade displayed on the display device of the customer device 101a. More specifically, it is processing as follows.

The CPU of the customer device 101a receives screen information for displaying an input screen of the foreign exchange trade on which the tradable price is offered from the management server 102. FIG. 5A, FIG. 5B, and FIG. 5C are views illustrating an example of the input screen of the foreign exchange trade. In this embodiment, the CPU of the customer device 101a displays the input screen of FIG. 5A, FIG. 5B, and FIG. 5C on the display part of the customer device 101a in S401.

First, the CPU of the customer device 101a displays an input screen 501 of FIG. 5A on the display part of the customer device 101a. The input screen 501 will be explained. The input screen 501 includes a display field 502, selection fields 503 to 505, and a button 506.

The display field 502 displays an tradable price. The customer A can input or choose trade details when making a trade while confirming the tradable price displayed on the display field 502.

The selection field 503 includes radio buttons corresponding to the “price request” and the “leave order” as order types. The CPU of the customer device 101a can specify whether the order type of the trade is set to the “price request” or the “leave order” by checking one of the radio buttons of the selection field 503 based on an operation by the customer A. The “price request” is an order type to deal at a tradable price for clients offered by a bank. The “leave order” is an order type to deal by the customer specifying a price (cost) to the bank.

A selection field 504 includes radio buttons corresponding to “buy foreign currency (import)” and “sell foreign currency (export)” as trade types. The CPU of the customer device 101a can specify whether the trade type of a trade is set to “buy foreign currency (import)” or to “sell foreign currency (export)” by checking one of the radio buttons of the selection field 504 based on an operation by the customer A.

A selection field 505 includes two radio buttons corresponding to “spot or outright forward trade” and “time option trade” as modes of trade. The CPU of the customer device 101a can specify whether the mode of trade is set to “spot or outright forward trade” or “time option trade” by checking one of the radio buttons of the selection field 505 based on an operation by the customer A. The “spot or outright forward trade” is, for example, a mode of trade to have a certain date in the future as a delivery date, for example Mar. 1, 2014. The “time option trade” is a mode of trade to have certain dates in the future as a start of period and an end of period, for example from Feb. 27, 2015 to Apr. 27, 2015, and a certain period from the start of period to the end of period as a delivery date. In this embodiment, it is assumed that the customer A selects the “price request” as the order type, the “buy foreign currency (import)” as the trade type, and the “time option trade” as the mode of trade.

Upon detecting a press down (selection) of the button 506 of the input screen 501 based on the operation by the customer A via the operating unit or the like of the customer device 101a, or the like, the CPU of the customer device 101a notifies the management server 102 of this detection. Upon accepting the notification of detection of the press down of the button 506 from the customer device 101a, the screen information providing part 301 of the management server 102 transmits screen information for displaying an input screen 511 of FIG. 5B to the customer device 101. Then, upon accepting the screen information for displaying the input screen 511 from the management server 102, the CPU of the customer device 101a displays the input screen 511 on the display part of the customer device 101a.

The input screen 511 of FIG. 5B will be explained. The input screen 511 includes a selection field 512, input fields 513, 514, and buttons 515, 516.

The selection field 512 includes a select box for selecting a currency pair. Upon detecting that one of items included in the select box of the selection field 512 is selected based on an operation by the customer A via the operating unit or the like of the customer device 101a, the CPU of the customer device 101a selects a currency pair used for the trade. In this embodiment, it is assumed that the CPU of the customer device 101a selects “USD/JPY”, that is, a currency pair of dollar and yen with the dollar being a base currency.

The input field 513 includes an input area of a trade amount. In this embodiment, the “buy foreign currency (import)” is selected in the selection field 504, and the “USD/JPY” is selected in the selection field 512. Thus, the input field 513 includes an input area of the trade amount for buying the dollar. The CPU of the customer device 101a obtains information of the trade amount inputted in the input area of the trade amount based on an operation by the customer A via the operating part of the customer device 101a or the like.

The input field 514 includes an input area of the due date of making a trade. In this embodiment, since the “time option trade” is selected in the selection field 505, the input field 514 includes an input area of the trade period in the time option trade, that is, the date of the first day of the trade period and the date of the last day of the trade period. The CPU of the customer device 101a obtains information of the trade period based on an input operation of date by the customer A into the input field 514 via the operating part or the like of the customer device 101a. Further, the customer device 101a may obtain information of the trade period based on the date specifying operation by the customer A via a calendar displayed on the input screen 511.

Upon detecting a press down (selection) of the button 515 or the button 516 based on an operation by the customer A via the input part or the like of the customer device 101a, the CPU of the customer device 101a notifies the management server 102 of this detection. Upon accepting the notification of detection of the press down of the button 515 from the customer device 101a, the screen information providing part 301 of the management server 102 transmits screen information for displaying the input screen 501 to the customer device 101. Further, upon accepting the notification of detection of a press down of the button 516 from the customer device 101a, the screen information providing part 301 of the management server 102 transmits screen information for displaying the input screen 521 illustrated in FIG. 5C to the customer device 101. Then, upon accepting the screen information for displaying the input screen 501 or the screen information for displaying the input screen 521 from the management server 102, the CPU of the customer device 101a displays the input screen 501 or the input screen 521 on the display part of the customer device 101a.

The input screen 521 illustrated in FIG. 5C will be explained. The input screen 521 includes input fields 522, 523, and buttons 524, 525.

The input field 522 includes an input area of “customer number”. The CPU of the customer device 101a obtains information of the customer number inputted in the input field of the “customer number” based on an operation by the customer A via the operating part or the like of the customer device 101a.

The input field 523 includes an input area of “memorandum”. The CPU of the customer device 101a obtains information of the memorandum inputted to the input area of the “memorandum” based on an operation by the customer A via the operating part or the like of the customer device 101a.

When desiring to inquire about the trade price used for trade with the contents of input in the input screens 501, 511, 521, the customer A presses down the button 524 via the operating part or the like of the customer device 101a, or when not desiring to inquire or willing to change the contents of input, the customer A presses down the button 525.

Upon detecting the press down of the button 524 or the button 525 based on an operation by the customer A via the operating part or the like of the customer device 101a, the customer device 101a notifies the management server 102 of this detection.

Upon accepting the notification of detection of a press down of the button 525 from the customer device 101, the screen information providing part 301 of the management server 102 transmits the screen information for displaying the input screen 511 again to the customer device 101. On the other hand, upon accepting the notification of detection of a press down of the button 524 from the customer device 101, the screen information providing part 301 notifies the trade detail accepting part 303 of this acceptance. Then, the trade details accepting part 303 transmits to the customer device 101 an acquisition request for trade details information inputted by the customer in the input screens 501, 511, 521.

The status specified in the selection fields 503 to 505, 512, and input fields 513, 514, 522, 523, and so on are an example of trade details of the trade made between the bank and the customer A. After obtaining information of the trade detail specified in the selection fields 503 to 505, 512, and the input fields 513, 514, 522, 523, and/or the like, the customer device 101a stores information of the obtained trade details in groups by trade in the storage device of the customer device 101a.

FIG. 6 is a diagram illustrating an example of the trade details information stored in the customer device 101a. The example of FIG. 6 illustrates that a trade is made under trade details that the buying or selling type is buying, the trade type is forward foreign exchange trade (price request), the trading currency is USD/JPY, the trade amount is 1 million currency units, and the delivery date is from Feb. 27, 2015 to Apr. 27, 2015.

Upon receiving the acquisition request for trade details from the management server 102, the customer device 101a transmits the trade details stored in the storage device of the customer device 101a or the like to the management server 102. The trade details accepting part 303 obtains the transmitted trade details.

In S402, the tradable price obtaining part 302 makes an acquisition request of the value of the trade price on a set due date of the currency pair specified in the selection field 512 to the multibank portal. In this embodiment, the tradable price obtaining part 302 makes an acquisition request for the tradable price (spot price) in two business days from the current date and time, and respective forward prices in 1 to 3 weeks, in 1 to 11 months, and in a year from the current date and time, to the multibank portal 103.

The spot price is a tradable price used in a trade to make a payment in two business days of the trade date. The forward price refers to a price used for a trade to make a payment of currency on a certain due date in three business days and thereafter from the trade date. The tradable price obtaining part 302 transmits, to the multibank portal, information of the currency pair specified in the selection field 512 and information of the date and time when the price is desired to be obtained, to thereby make an acquisition request of the price (spot price, and forward price).

In the processing of this embodiment, the tradable price obtaining part 302 performs the processing of S402 after the processing of S401. However, the tradable price obtaining part 302 may periodically execute the processing of S402, such as once every 15 minutes. Further, the tradable price obtaining part 302 may make the acquisition request, for example, once every 5 seconds to the multibank portal 103 for the spot price which requires a more accurate value.

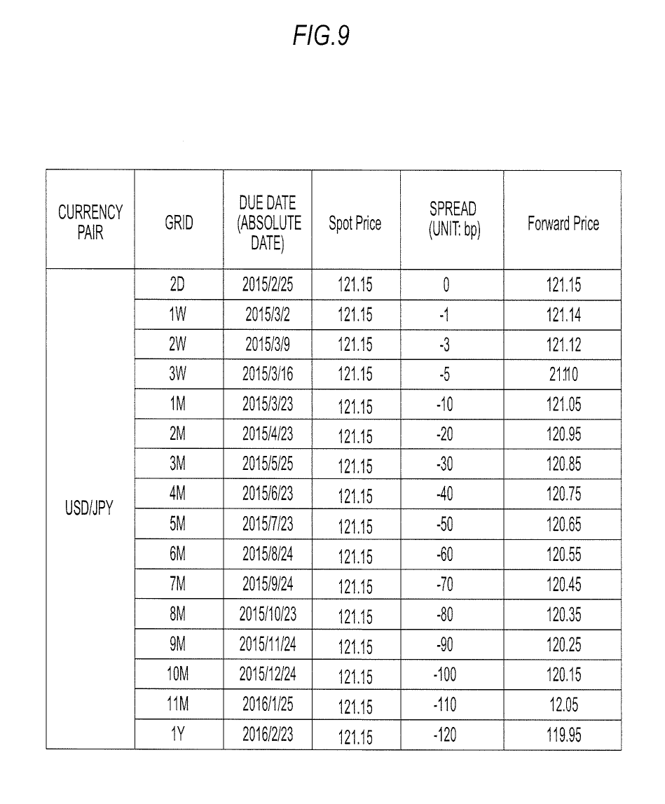

In S403, the multibank portal 103 obtains data of the spot price of the currency pair specified in the selection field 512 and the forward price of the specified date, the spread, and the like in response to the tradable price acquisition request transmitted in S402. The multibank portal 103 obtains information of the currency pair specified in the selection field 512 and the tradable price by sending or receiving trade details with the plurality of market maker devices 104. In this embodiment, since the currency pair is the dollar/yen and the base currency is the dollar, the forward price obtained in S403 is a value indicating that one dollar is equivalent to how much yen. Details of data obtained from the multibank portal 103 in S403 will be described with FIG. 9. The multibank portal 103 transmits obtained data to the management server 102. The tradable price obtaining part 302 receives data transmitted from the multibank portal 103, and stores the data in a database (DB) stored in the HD 204 or the like. The interest rate structure determining part 304 can read latest data from this DB.

In S404, the interest rate structure determining part 304 and the tradable price calculating part 305 calculate the tradable price which is the price used in the time option trade made between the bank and the customer A. The interest rate structure determining part 304 determines the interest rate structure in the trade period of the time option trade with the customer A, and determines the reference date corresponding to the forward price used for calculating the tradable price based on the determined interest rate structure. The tradable price calculating part 305 calculates the tradable price used in the time option trade with the customer A by adding a spread of each banks to the forward price on the determined reference date, or the like. Details of the processing of S404 will be described later with FIG. 8.

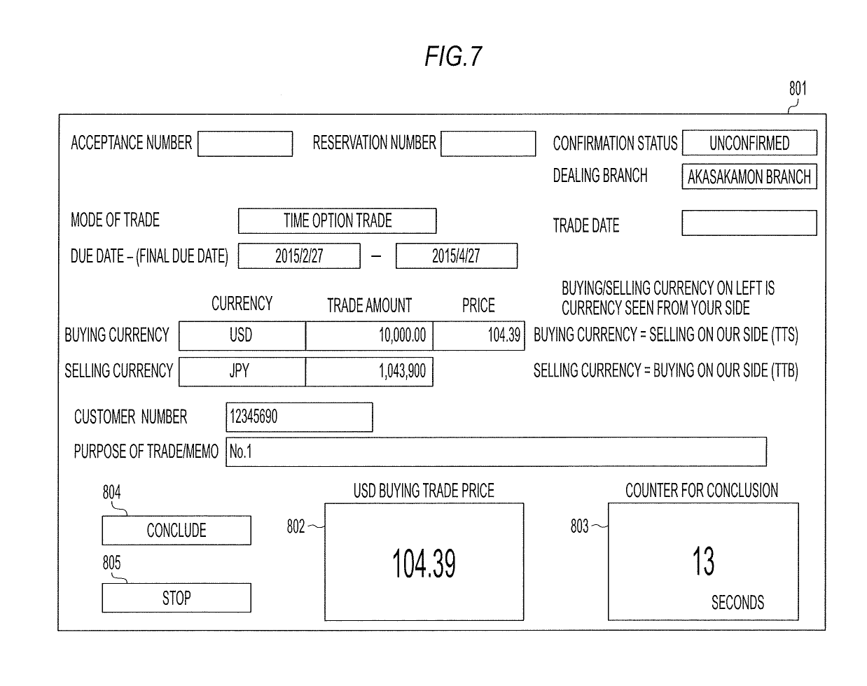

In S405, the screen information providing part 301 transmits to the customer device 101a screen information for displaying a tradable price offering screen for offering the tradable price calculated in S404. In this embodiment, the tradable price offering screen is an input screen 801 illustrated in FIG. 7. The CPU of the customer device 101a displays an input screen 801 on the display part of the customer device 101a based on the transmitted screen information.

FIG. 7 is a view illustrating an example of an input screen 801 displayed on the display device 206 of the customer device 101a. In a display field 802, the tradable price calculated by the tradable price calculating part 305 is displayed. In the example of FIG. 7, the tradable price of the bought is displayed. This allows the customer A to determine whether to conclude the foreign exchange trade with reference to the tradable price offered by the management server 102.

When willing to conclude the foreign exchange trade at the tradable price displayed in the display field 802, the customer A presses down the button 805 via the operating part or the like of the customer device 101a. On the other hand, when not willing to conclude the foreign exchange trade at the tradable price displayed in the display field 802, the customer A does not press down the button 805 via the operating part or the like of the customer device 101a. In a display field 803, a time in which the customer can press down the button 804 from the moment that a tradable price for clients is offered in the display field 802 is displayed by counting down. For example, when “30 seconds” is displayed in the display field 803, the trade will not be closed unless the customer A presses down the button 804 within 30 seconds from the point of time that the “30 seconds” is displayed in the display field 803. Upon detecting the press down of the button 804 or the button 805 by the customer, the CPU of the customer device 101a notifies the management server 102 of this detection.

In S406, upon detecting the press down of the button 804 by the customer, the customer device 101a notifies the management server 102 of this detection.

In S407, upon notification by the customer device 101a in S406, the foreign exchange trade executing part 306, seeing that the time option trade is concluded with the customer A, determines the due date of making a cover deal about the concluded time option trade. Then, the foreign exchange trade executing part 306 makes a request for the cover deal on the determined due date to the multibank portal 103.

The cover deal is a foreign exchange trade to cancel out the position occurred in the foreign exchange trade concluded between the bank and the customer. The foreign exchange risk can be hedged by making a trade opposite to the trade accepted from the customer. The cover deal is made by a spot trade or a foreign exchange trade in the interbank market. The cover deal cannot be made as the time option trade in trading in the interbank market, and will be made as the spot or outright forward trade. Thus, in the cover deal, it is necessary to specify the due date for making the spot or outright forward trade.

Also in the cover deal, the first day or the last day of the trade period of the time option trade is the due date, and a foreign exchange trade on the due date is ordered in the interbank market at the tradable price offered from the trade partner of the cover deal. When the order is concluded with another bank, the foreign exchange trade is closed.

The cover deal is a risk hedge trade and is to cancel out a customer's trade, and thus the cover deal is made by using the due date used in the customer's trade (due date corresponding to the forward price which is referred when the tradable price is calculated in S404). Details of the processing of S407 will be described later in an explanation of the cover deal.

In S408, the foreign exchange trade executing part 306 makes the cover deal for the time option trade concluded with the customer A in the interbank market at the tradable price offered from the counterparty on the date and time determined in S407. The foreign exchange trade executing part 306 transmits information specifying the conclusion of the cover deal to the cover deal counterparty, so as to order the cover deal. The processing of S408 is an example of cover deal ordering processing.

### (Explanation of Calculation Processing of the Tradable Price)

FIG. 8 is a flowchart illustrating an example of tradable price calculating processing. The processing of FIG. 8 includes details of the processing of S404. Details of the processing of S404 will be explained using FIG. 8.

In S601, the interest rate structure determining part 304 performs following processing based on data obtained from the multibank portal 103 in S403. Specifically, the interest rate structure determining part 304 obtains the spread of the currency pair (dollar/yen) specified in the selection field 512 on a specific due date (in each of two days, one week to three weeks, one month to 11 months, one year after the present).

The spread is a difference between the forward price and the spot price. Further, the spread on a given due date is obtained simply with following expression 3 in a simplified manner from the spot price, the interest rate difference of the currency pair, and the number of days from the current date until the due date.

Spread=spot price*interest rate difference of currency pair*(the number of days from date corresponding to spot price until due date/365) (expression 3)

Further, strictly speaking, the spread can be obtained with following expression 4.

Spread=spot price−spot price×(1+(interest of yen)×(number of days from current date until due date/365)/(1+(interest rate of dollar)×(number of days from date corresponding to spot price until due date)/360) (expression 4)

FIG. 9 is a diagram illustrating the spread on a specific due date. Data of FIG. 9 illustrate details of data transmitted from the multibank portal 103 in S403. The prices provided in FIG. 9 are fictional prices for explanation and are not real prices. The “currency pair” of data of FIG. 9 indicates the currency pair (dollar/yen) specified in the selection field 512. The “grid” of data of FIG. 9 indicates how many days there are until the date of the corresponding data after the current date and time.

The “due date” of data of FIG. 9 indicates the date corresponding to the grid. The “spot price” of data of FIG. 9 indicates the spot price. The “spread” of data of FIG. 9 indicates the spread. The “forward price” of data of FIG. 9 indicates the forward price. The interest rate structure determining part 304 obtains information of spread by referring to the data of the item “spread” of the date of FIG. 9.

In this embodiment, the multibank portal 103 transmits the information of spread together with the tradable price (spot price, forward price) information, but may also transmit only the tradable price information. In this case, the interest rate structure determining part 304 obtains the spread by calculating the difference between the spot price and the forward price from the information of the transmitted tradable price.

The multibank portal 103 obtains data of FIG. 9 separately for BID (bank buys/customer sells) and OFFER (bank sells/customer buys). When the date of the grid is a holiday, the next business day will be the due date.

In S602, the interest rate structure determining part 304 interpolates the spread of the first day and the last day of the trade period of the time option trade with the customer A based on the spread obtained in S601.

The data of the spread obtained from the multibank portal 103 in S403 is data of a specific day in two days, one week, two weeks, . . . after the foreign exchange trade date, but the first day and the last day of the trade period are optional dates. Accordingly, the data obtained from the multibank portal 103 in S403 mostly do not include data of the spread of the first day and the last day of the trade period.

The interest rate structure determining part 304 then performs an interpolation using data of the spread obtained from the multibank portal 103 in S403, so as to obtain the spread of the first day and the last day of the trade period. In this embodiment, the interest rate structure determining part 304 performs a linear interpolation of the data of the spread obtained from the multibank portal 103 in S403, so as to obtain the spread of the first day and the last day of the trade period.

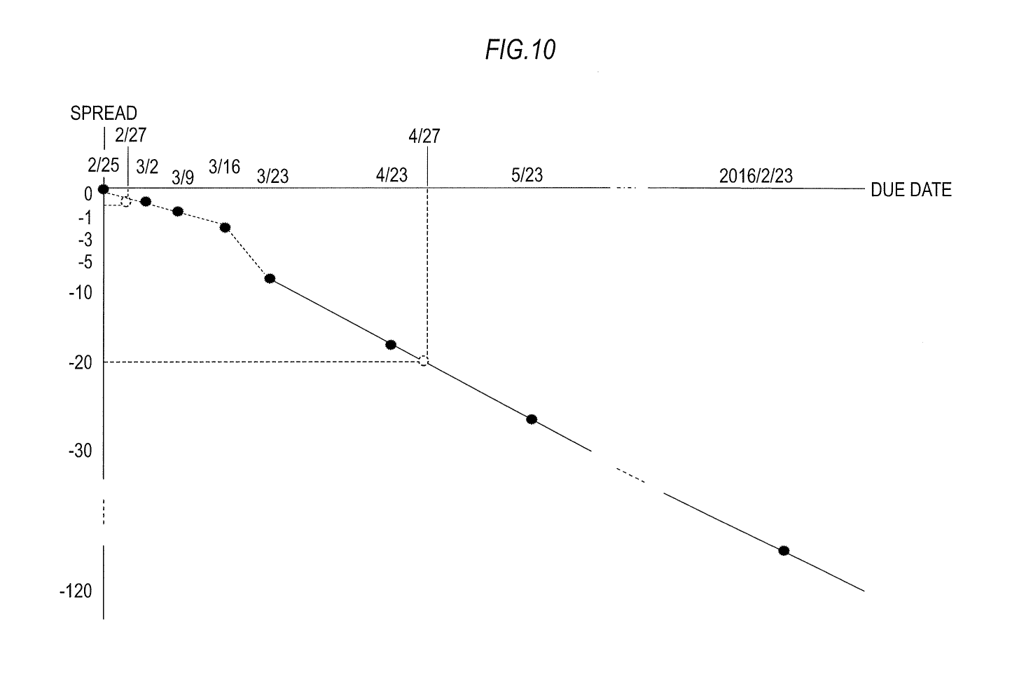

FIG. 10 is a graph explaining interpolation processing. Interpolation processing of the spread of the first day and the last day of the trade period in S602 will be explained using FIG. 10.

In this embodiment, the foreign exchange trade date is Feb. 23, 2015. Accordingly, the spread transmitted in S403 is spread in Feb. 25, Mar. 2, Mar. 9, Mar. 16, Mar. 23, Apr. 23, May 23, 2015, . . . Feb. 23, 2016.

The vertical axis of the graph of FIG. 10 represents the value of the spread, and the horizontal axis indicates the due date. The graph of FIG. 10 illustrates how the spread transmitted in S403 is plotted. Black dots in the graph respectively indicate the spreads transmitted in S403.

In the example of FIG. 10, the spreads of one month to one year are in a linear relation with respect to the due date, but it does not always become a linear relation.

As in expression 3, the spread is determined according to the interest rate difference of currencies of the two countries of the currency pair. The interest rate difference may expand or shrink as the due date becomes further forward, or the plus or minus of the interest rate difference may reverse in every due date.

The first day and the last day of the trade period of the time option trade made in this embodiment are Feb. 27, 2015 and Apr. 27, 2015, respectively. Thus, there is no spread corresponding to the first day and the last day of the trade period in the information transmitted in S403.

A general expression for linearly interpolating the spread in a certain due date is as following expression 5.

Y=Y1+((Y2−Y1)*(X−X1)/(X2−X1)) (expression 5)

In expression 5, Y is a spread on a certain due date. X in expression 5 is the number of days from a day (two days after the foreign exchange trade date) corresponding to the spot price to the due date corresponding to Y. Y1 in expression 5 is a spread of a due date immediately before the due date corresponding to Y in the spread transmitted in S403. X1 in expression 5 is the number of days from the day corresponding to the spot price to the due date corresponding to Y1.

Y2 in expression 5 is a spread of a due date immediately after the due date corresponding to Y in the spread transmitted in S403. X2 in expression 5 is the number of days from the day corresponding to the spot price to the due date corresponding to Y2. X1, X2, Y1, Y2 are included in data obtained from the multibank portal 103 in S403.

The interest rate structure determining part 304 performs following processing to obtain the spread of Feb. 27, 2015 which is the first day of the trade period. First, the interest rate structure determining part 304 obtains the spread of the due date immediately before Feb. 27, 2015 and the spread of the due date immediately after Feb. 27, 2015 from the spread transmitted in S403. The interest rate structure determining part 304 obtains the spread of Feb. 25, 2015 as the spread of the due date immediately before Feb. 27, 2015, and obtains the spread of Mar. 2, 2015 as the spread of the due date immediately after Feb. 27, 2015.

Then, the interest rate structure determining part 304 calculates the spread of Feb. 27, 2015. The interest rate structure determining part 304 determines the number of days from Feb. 25, 2015 until Feb. 27, 2015 as X, the spread of Feb. 25, 2015 as Y1, and the number of days from Feb. 25, 2015 until Feb. 25, 2015 as X1. Further, the interest rate structure determining part 304 determines the spread of Mar. 2, 2015 as Y2, and the number of days from Feb. 25, 2015 to Mar. 2, 2015 as X2. The interest rate structure determining part 304 substitutes the determined X, X1, X2, Y1, Y2 in expression 5, and calculates the spread Y of Feb. 27, 2015.

X is 2 (February 25 to February 27), X1 is 0 (February 25 to February 25), X2 is 5 (February 25 to March 2), Y1 is 0 (February 25), and Y2 is −1 (March 2). Accordingly, the spread of February 27 is 0+((−1−0)*(2−0)/(5−0))=−0.4.

The interest rate structure determining part 304 performs following processing for obtaining the spread of Apr. 27, 2015 which is the first day of the trade period. First, the interest rate structure determining part 304 obtains the spread of the due date immediately before Apr. 27, 2015 and the spread of the due date immediately after Apr. 27, 2015 from the spread transmitted in S403. The interest rate structure determining part 304 obtains the spread of Apr. 23, 2015 as the spread of the due date immediately before Apr. 27, 2015, and obtains the spread of May 23, 2015 as the spread of the due date immediately after Apr. 27, 2015.

Then, the interest rate structure determining part 304 calculates the spread of Apr. 27, 2015. The interest rate structure determining part 304 determines the number of days from Feb. 25, 2015 until Apr. 27, 2015 as X, the spread of Apr. 23, 2015 as Y1, and the number of days from Feb. 25, 2015 until Apr. 23, 2015 as X1. Further, the interest rate structure determining part 304 determines the spread of May 23, 2015 as Y2, and the number of days from Feb. 25, 2015 to May 23, 2015 as X2. The interest rate structure determining part 304 substitutes the determined X, X1, X2, Y1, Y2 in expression 5, and calculates the spread Y of Apr. 27, 2015.

X is 61 (February 25 to April 27), X1 is 57 (February 25 to April 23), X2 is 87 (February 25 to May 23), Y1 is −20 (April 23), and Y2 is −30 (May 23). Accordingly, the spread of April 27 is −20+((−30−20)*(61−57)/(87−57))=−21.33.

The interest rate structure determining part 304 uses the linear interpolation as the method of interpolation, and this has following effects in comparison with the case where a polynomial equation interpolation is used. That is, the interest rate structure determining part 304 needs a minimum number of data used for the interpolation, which are two pieces of data on both sides, and needs lighter calculation processing as compared to interpolation of polynomial equation. Accordingly, the interest rate structure determining part 304 can reduce the used resource, and can accelerate processing.

The interest rate structure determining part 304 may use a polynomial equation interpolation such as spline interpolation and Lagrange interpolation, or the like as the method of interpolation. When using the polynomial equation interpolation, the interest rate structure determining part 304 can obtain not only data on both sides of the interpolation target point but also interpolation values in consideration of other data.

In S603, the interest rate structure determining part 304 determines the interest rate structure of the trade period based on the spread of the first day and the last day of the trade period interpolated in S602.

When the spread of the first day of the trade period is equal to or more than the spread of the last day of the trade period, the interest rate structure determining part 304 determines that the interest rate structure is discount because the value of the base currency decreases with passage of the period. In this embodiment, since the currency pair is the dollar/yen and the base currency is the dollar, the yen gets stronger against the dollar with passage of the period when the interest rate structure is discount. The interest rate structure of discount is an example of a first interest rate structure.

When the spread of the first day of the trade period is smaller than the spread of the last day of the trade period, the interest rate structure determining part 304 determines that the interest rate structure is premium because the value of the base currency increases with passage of the period. In this embodiment, since the currency pair is the dollar/yen and the base currency is the dollar, the yen gets weaker against the dollar with passage of the period when the interest rate structure is premium. The interest rate structure of premium is an example of a second interest rate structure.

The interest rate structure determining part 304 proceeds to processing of S604 when determined that the interest rate structure of the trade period is premium, or proceeds to processing of S605 when determined that the interest rate structure of the trade period is discount.

In this embodiment, when the spread of the first day of the trade period is equal to the spread of the last day of the trade period, the interest rate structure determining part 304 determines it as discount, but may also determine it as premium depending on the request specification.

The spread of the first day of the trade period calculated in S602 is −0.4, and the spread of the last day of the trade period is −21.33. Accordingly, the interest rate structure determining part 304, seeing that in the interest rate structure of the trade period the spread of the first day of the trade period is larger than the spread of the last day of the trade period, determines that the interest rate structure of the trade period (Feb. 27, 2015 to Apr. 27, 2015) is discount.

In S604, the tradable price calculating part 305 determines whether the time option trade with the customer A is a trade that the bank buys the base currency.

More specifically, the tradable price calculating part 305 refers to information inputted in the selection field 504 in the trade details transmitted from the customer device 101a in S401. When the information inputted in the input field 504 is “buy foreign currency (import)”, it indicates that the customer A buys the dollar as the base currency which is a foreign currency, and thus the tradable price calculating part 305 determines that the trade with the customer A is a trade that the bank side sells the dollar as the base currency to the customer A.

Further, when the trade details inputted in the selection field 504 is “sell foreign currency (export)”, it indicates that the customer A sells the dollar as the base currency which is a foreign currency, and thus the tradable price calculating part 305 determines that the trade with the customer A is a trade that the bank side buys the dollar as the base currency from the customer A. In this case, it is a trade of BID (bank sells/customer buys) of the bank of the dollar/yen. For example, when the customer A as an exporting company changes dollars earned by exporting to the yen, the exporting company execute a trade to sell the dollars to the bank.

The tradable price calculating part 305 proceeds to processing of S607 when determined that the time option trade with the customer A is a trade that the bank side buys the base currency, or proceeds to processing of S606 when determined that the time option trade with the customer A is a trade that the bank side sells the base currency.

In S605, the tradable price calculating part 305 determines whether the time option trade with the customer A is a trade that the bank side buys the base currency. The contents of determination processing are the same as S604.

The tradable price calculating part 305 proceeds to processing of S608 when determined that the time option trade with the customer A is a trade that the bank side buys the base currency, or proceeds to processing of S609 when determined that the time option trade with the customer A is a trade that the bank side sells the base currency.

In S606, the tradable price calculating part 305 determines that the last day of the trade period of the time option trade with the customer A as the reference day for determining the forward price used for calculating the tradable price used for the time option trade with the customer A.

In S607, the tradable price calculating part 305 determines that the first day of the trade period of the time option trade with the customer A as the reference day for determining the forward price used for calculating the tradable price used for the time option trade with the customer A.

Processing of S608 is the same as the processing of S606.

Processing of S609 is the same as the processing of S607.

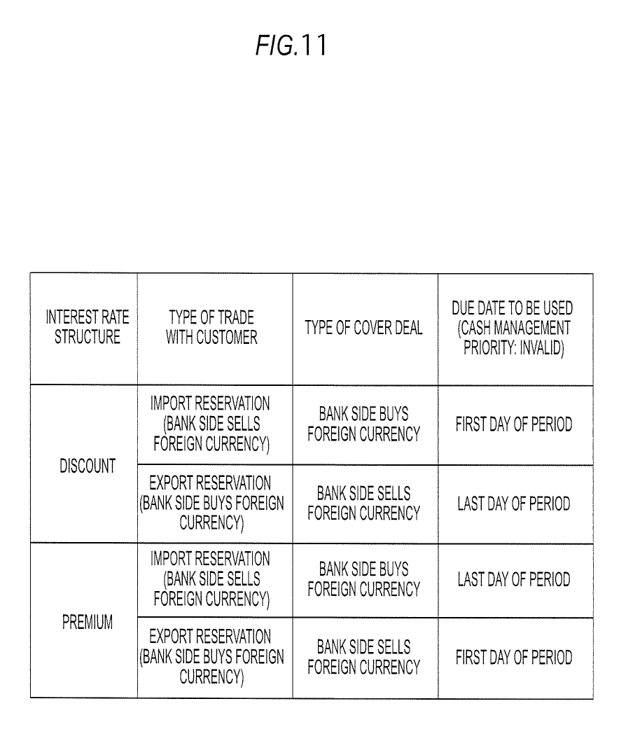

The tradable price calculating part 305 may execute following processing instead of performing processing of S604 to S609. That is, the tradable price calculating part 305 may refer to a table illustrated in FIG. 11, which illustrates the correspondence between the interest rate structure with the trade type and the reference day, recorded in advance in the HD 204 or the like, so as to determine the reference day.

In this case, the tradable price calculating part 305 determines as the reference day the “due date to be used” corresponding to the interest rate structure determined in S603 and the trade type corresponding to information inputted in the selection field 504 from the table of FIG. 11.

In S610, the tradable price calculating part 305 calculates the forward price on the reference day determined in any one of S606 to S609. The tradable price calculating part 305 calculates the forward price of the reference day by a spread, which is spot price+0.01*reference day. The spread represents the unit bp (basis point), and when converting it into an against currency (the yen in the case of the dollar/yen) of the currency pair, it is converted by multiplying 1/100.

In the case of this embodiment, the forward price of April 27 of the last day of the time option trade on February 23 of the trade date calculated by the tradable price calculating part 305 is 121.15+0.01*(−21.33)=120.94. The tradable price calculating part 305 calculates a price to which a margin or the like set for the bank is added as the tradable price with respect to the calculated forward price on the reference day.

The time option trade is a trade to exchange currencies at a trade price in the trade period. For example, when the trade of 1 million currency units is made, it is a trade to exchange currencies at a trade price in the trade period from Feb. 27, 2015 to Apr. 27, 2015.

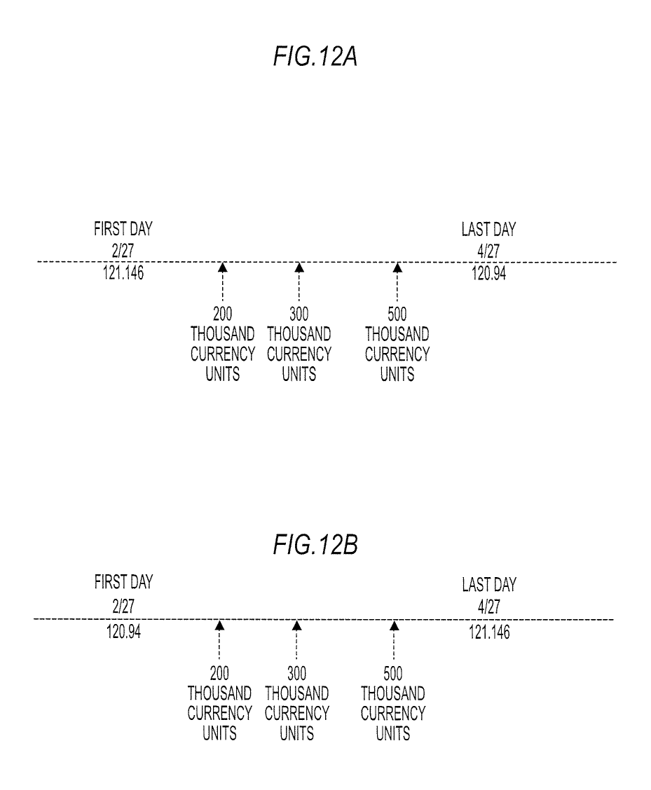

FIG. 12A and FIG. 12B are diagrams explaining the time option trade.

As in the example of FIG. 12A and FIG. 12B it is assumed that requests for delivery of currencies are received sporadically in the trade period. FIG. 12A illustrates that the tradable price of February 27, the first day of the trade period is 121.146 yen/dollar, and the tradable price of April 27, the last day of the trade period is 120.94 yen/dollar. If the interest rate structure is discount as in the example of FIG. 12A, when the bank buys a foreign currency from the customer, it is more advantageous for the bank to buy at the tradable price of the last day of the trade period for any of the currency delivery requests.

Conversely, when the bank sells a foreign currency to the customer, it is more advantageous to sell at the tradable price of the first day of the period for any of the currency delivery requests.

FIG. 12B illustrates that the tradable price of February 27, the first day of the trade period is 120.94 yen/dollar, and the tradable price of April 27, the last day of the trade period is 121.146 yen/dollar.

As in the example of FIG. 12B, when the interest rate structure is premium, conversely to the case of discount, when the bank buys a foreign currency from the customer it is advantageous for the bank to buy at the tradable price of the first day of the period for any of the delivery requests.

If the bank sells a foreign currency to the customer when the interest rate structure is premium, it is advantageous to sell at the price of the last day of the trade period for any of the delivery requests.

(Explanation of Cover Deal)

In order to reduce the risk of foreign exchange, the bank makes a cover deal. The cover deal is a deal for having a position to cancel out a position which occurs in trading with the customer. Further, the cover deal is made in the interbank market, and the trade of the time option trade is not made in the interbank market. Thus, it is necessary to determine the date and time for exchanging currencies by the spot or outright forward trade. Therefore, the tradable price calculating part 305 determines that the date and time when currencies are exchanged by the cover deal as the reference day determined in any of S606 to S609. Further, normally, the tradable price in the cover deal is offered from the counterparty of the cover deal. However, the tradable price calculating part 305 may obtain the tradable price in the cover deal based on the forward price on the reference day determined in any of S606 to S609. Then, the trade executing part 306 may conclude the cover deal by using the obtained tradable price.

For example, if it is a trade that the bank buys a foreign currency from the customer, the bank makes a trade to sell a foreign currency so as to cancel out the foreign exchange trade with the customer in the interbank market.

In this embodiment, in S610, the tradable price calculating part 305 calculates the tradable price based on the forward price of the last day of the trade period. Accordingly, as the cover deal, the bank looks for a partner of a trade on the last day of the trade period in the trade with the customer A in the interbank market. In the interbank market, connections among banks or with brokers are via dedicated lines, a bank offers a trade with the last day of a trade period being the delivery due date, and if another bank that accepts the trade is found, the trade of the cover deal is concluded.

Note that in the interbank market, the time option trade is not made, and thus the total amount of the currency is delivered on the last day of the trade period.

As described above, the processing of this embodiment enables the trade processing system to interpolate the trade indexes of the first day and the last day of the trade period of the time option trade, so as to obtain more accurate trade indexes of the first day and the last day of the trade period. The trade processing system does not consider all the details of the obtained trade indexes during the interpolation, but uses only a few pieces of information around an interpolation point to perform interpolation. Thus, trade processing becomes quicker than processing all the information of the trade indexes obtained, and hence high speed can be achieved. Further, the needed amount of memory to be used is less than that in processing all the information of the trade indexes obtained. The trade processing system can determine the interest rate structure of the trade period more quickly and accurately based on the interpolated trade indexes.

The trade processing system calculates the tradable price based on the forward price of the first day or last day of the trade period according to the interest rate structure of the determined trade period. Accordingly, the trade processing system can quickly calculate the tradable price which yields the largest profit for the bank.

Further, the trade processing system determines the reference day corresponding to the forward price used for calculating the tradable price as the date and time of the cover deal. Accordingly, the trade processing system can easily determine the date and time of the cover deal based on the reference day, and can conclude the cover deal.

### Embodiment 2

In the embodiment 1, the processing when the customer makes a price inquiry and makes a trade of the time option trade is explained. However, the processing of embodiment 1 can also be applied to the trade of the time option trade and the cover deal thereof by the leave order (limit order).

In the case of the leave order, the information processing system accepts a desired rate from the customer, and concludes, in the course of fluctuations of the tradable price, a trade at the point when the bank determines that this rate is acceptable. That is, the tradable price of the trade which is acceptable for the bank side fluctuates according to the fluctuations of the tradable price, and thus the trade processing system determines a separation between the rate desired by the customer and the tradable price assumed by the bank, and concludes the trade when the separation value is within a tolerable range.

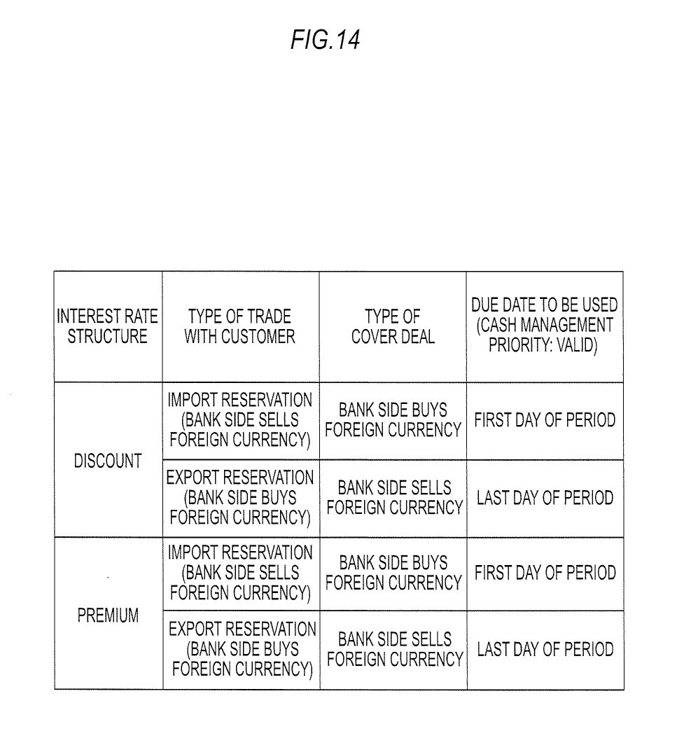

Here, the tradable price anticipated by the bank is, similarly to Embodiment 1, calculated based on either the first day or the last day of the specific period. That is, the tradable price calculating part 305 calculates the tradable price by using the forward price of the first day or the last day of the period according to the setting of FIG. 11 or FIG. 14 which will be described later, according to whether the interest rate structure is discount or premium. Then, when the difference between the calculated tradable price and the desired rate (limit order) of the customer is smaller than a set threshold, the trade of the time option trade is concluded at the limit order price of the customer. Regarding the value of the set threshold indicating the tolerance range of the difference between the calculated tradable price and the desired price of the customer is set in advance by the user and recorded in the HD 204 or the like in the format of a setting file or the like.

The system configuration of the trade processing system of this embodiment and the hardware configuration and functional configuration of the components of the trade processing system are similar to those of Embodiment 1.

The processing of this embodiment differs in S401 and S405 in comparison with the processing of Embodiment 1. A part different from Embodiment 1 in the processing of this embodiment will be explained.

In S401, the customer device 101a performs processing similar to Embodiment 1, and transmits information of a desired rate to the management server 102. The customer device 101a obtains the trade details of a desired price which is a price desired by the user based on an operation by the user via the input device of the customer device 101a, and transmits trade details of the obtained desired rate to the management server 102. The processing to obtain trade details of the desired price which is a rate desired by the user in S401 is an example of limit order accepting processing.

In S405, the screen trade details providing part 301 performs following processing when the difference between the tradable price calculated in S404 and the desired price transmitted in S401 is equal to or less than the set threshold. Specifically, the screen information providing part 301 transmits to the customer device 101a screen information for displaying the tradable price offering screen for offering a concluded tradable price. Further, when the difference between the tradable price calculated in S404 and the desired rate transmitted in S401 is larger than the set threshold, the screen trade details providing part 301 performs following processing. Specifically, the screen trade details providing part 301 transmits to the customer device 101a screen trade details for displaying a screen which provides that the trade at the price desired by the customer cannot be made.

Then, when detected a press down of the button 804 by the customer in S406, the customer device 101a notifies the management server 102 of this detection, thereby concluding the trade. The processing of S405 and S406 of this embodiment is an example of leave order concluding processing.

As described above, the processing of this embodiment enables the trade processing system to determine whether a trade is possible or not when a leave order (limit order) is specified by the customer.

### Embodiment 3

In this embodiment, a calculation method of a tradable price in consideration of whether to give priority to cash management will be explained.

The system configuration of the trade processing system of this embodiment and the hardware configuration and functional configuration of the components of the trade processing system are similar to those of Embodiment 1.

In a trade with a customer, cash management can be a problem. For example, a bank having a small quantity of foreign currency cannot deliver a foreign currency to the counterparty in a trade with the customer or a cover deal thereof. Thus, the bank needs to prepare a quantity of foreign currency of which a trade may occur until the delivery due date.

Thus, when the bank sells a foreign currency to the customer, the bank needs to buy in advance the foreign currency from the interbank market at the point of the first day of the period, so as to be able to deliver the foreign currency to the customer at any time in the trade period. That is, the bank needs to make a trade with the interbank market in which the first day of the trade period is the delivery date. This trade corresponds to the cover deal. Therefore, the bank sets a tradable price based on the forward price of the first day of the trade period in the foreign exchange trade of the time option trade with the customer to be canceled out by this cover deal.

On the other hand, when the bank buys a foreign currency from the customer, the bank cannot sell the foreign currency to the interbank market in the cover deal unless the entire quantity of the foreign currency received from the customer in the trade period is collected. Thus, the foreign currency can be sold to the interbank market at the point of the last day of the trade period. That is, the bank needs to perform a trade in which the last day of the trade period is the delivery due date with the interbank market. This trade corresponds to the cover deal. Therefore, the bank sets the tradable price based on the forward price of the last day of the trade period also in the trade of the time option trade with the customer which will be canceled out by the cover deal.

FIG. 13 is a flowchart illustrating an example of the tradable price calculating processing in consideration of cash management. The processing of FIG. 13 is different from the processing of FIG. 8 in that processing of S1401 is added. The difference of the processing of FIG. 13 from FIG. 8 will be explained.

In S1401, the tradable price calculating part 305 determines whether to give priority to cash management based on cash management priority information stored in the HD 204 or the like. The cash management priority information is information which can take one of two values, such as ON and OFF, YES and NO, or 1 and 0. When the cash management priority information is ON (or YES or 1), the tradable price calculating part 305 determines to give priority to cash management. Further, when the cash management priority information is OFF (or NO or 0), the tradable price calculating part 305 determines not to give priority to cash management.

The CPU 201 can change the contents (such as switching ON, OFF) of the cash management priority information stored in the HD 204 or the like based on the operation by the user of the management server 102 via the input device 205.

The tradable price calculating part 305 proceeds to processing of S605 when determined to give priority to cash management, or proceeds to processing of S604 when determined not to give priority to cash management.

The tradable price calculating part 305 may execute following processing instead of performing processing of S604 to S609, S1401. That is, the tradable price calculating part 305 may refer to a table, which illustrates the correspondence of the interest rate structure, the trade type, and the reference day, illustrated in FIG. 14 and recorded in advance in the HD 204 or the like, so as to determine the reference day.

In this case, the tradable price calculating part 305 determines as the reference day the “due date to be used” corresponding to the interest rate structure determined in S603 and the trade type corresponding to information inputted in the selection field 504 from the table of FIG. 14.

Comparing FIG. 14 and FIG. 11, it can be seen that the “due date to be used” is the same when the interest rate structure is discount, but the “due date to be used” is different when the interest rate structure is premium.

Further, the tradable price calculating part 305 may determine the reference day based on the table of FIG. 11 when the cash management priority information is OFF or the like, or may determine the reference day based on the table of FIG. 14 when the cash management priority information is ON or the like.

Thus, by the processing of this embodiment, the information processing system exhibits the effect of Embodiment 1, and can determine the tradable price in consideration of whether the bank gives priority to cash management in the time option trade.

### Embodiment 4

In Embodiments 1 to 3, the interest rate structure determining part 304, taking the spread as the trade index, interpolates the spread in the first day and the last day of the trade period of the time option trade. Then, the interest rate structure determining part 304 determines whether the trade index of the first day of the interpolated trade period is equal to or more than the trade index of the last day of the interpolated trade period, to thereby determine the interest rate structure of the trade period.

However, in this embodiment, processing using an interest rate difference of forward prices or a currency pair as the trade index will be explained.

The system configuration of the information processing system of this embodiment and the hardware configuration and functional configuration of the components of the trade processing system are similar to those of Embodiment 1.

The processing of this embodiment differs in S601 to S603 in comparison with the processing of Embodiment 1. A part different from Embodiment 1 in the processing of this embodiment will be explained.

First, processing of the interest rate structure determining part 304 will be explained, including taking the forward price as the trade index, interpolating the forward prices at the first day and the last day of the trade period from the information of the forward price received from the multibank portal, and determining the interest rate structure of the trade period based on the interpolated forward price.

In S601, the interest rate structure determining part 304 performs following processing based on data obtained from the multibank portal 103 in S403. Specifically, the interest rate structure determining part 304 obtains the tradable price (spot price, forward price) of the currency pair (dollar/yen) specified in the selection field 512 on a specific due date (in each of two days, one week to three weeks, one month to 11 months, and one year after the present).

In S602, the interest rate structure determining part 304 interpolates the forward prices of the first day and the last day of the trade period of the time option trade with the customer A based on the forward price obtained in S601.

A general expression for linearly interpolating the forward price in a certain due date is as following expression 6.

Y=Y1+((Y2−Y1)−X1)/(X2−X1)) (expression 6)

In expression 6, Y is a forward price on a certain due date. X in expression 6 is the number of days from a day (two days after the trade date) corresponding to the spot price to the due date corresponding to Y. Y1 in expression 6 is a forward price of a due date immediately before the due date corresponding to Y among forward prices transmitted in S403. X1 in expression 6 is the number of days from the day corresponding to the spot price to the due date corresponding to Y1.

Y2 in expression 6 is a forward price of a due date immediately after the due date corresponding to Y among the forward prices transmitted in S403. X2 in expression 6 is the number of days from the day corresponding to the spot price to the due date corresponding to Y2. X1, X2, Y1, Y2 are included in data obtained from the multibank portal 103 in S403.

The interest rate structure determining part 304 obtains X1, X2, Y1, Y2 from the data transmitted in S403, and obtains X from the foreign exchange trade date and the first day or the last day of the trade period. The interest rate structure determining part 304 obtains the forward price of the first day or the last day of the period using expression 6 based on the obtained X, X1, X2, Y1, Y2.

In S603, the interest rate structure determining part 304 determines the interest rate structure of the trade period based on the forward prices of the first day and the last day of the trade period interpolated in S602.

When the forward price of the first day of the trade period is equal to or more than the forward price of the last day of the trade period, the interest rate structure determining part 304 determines that the interest rate structure is discount because the value of the base currency decreases with passage of the period. In this embodiment, since the currency pair is the dollar/yen and the base currency is the dollar, the yen gets stronger against the dollar with passage of the period when the interest rate structure is discount.

When the spread of the first day of the trade period is smaller than the spread of the last day of the trade period, the interest rate structure determining part 304 determines that the interest rate structure is premium because the value of the base currency increases with passage of the period. In this embodiment, since the currency pair is the dollar/yen and the base currency is the dollar, the yen gets weaker against the dollar with passage of the period when the interest rate structure is premium.

Through the above-described processing, when it could only obtain the forward price, the interest rate structure determining part 304 uses the forward price as the trade index, to thereby be able to determine the interest rate structure of the trade period without performing the processing of obtaining the spread. Further, the tradable price calculating part 305 just needs to obtain the forward price interpolated by the interest rate structure determining part 304 when obtaining the forward price on the reference day, thereby alleviating a load of processing of calculating the forward price on the reference day.

Next, processing of the interest rate structure determining part 304 will be explained, including taking values of (interest rate difference of currency pair)×(number of days from foreign exchange trade date to due date)/365 as the trade indexes, interpolating the values of the trade indexes of the first day and the last day of the specific period from interest rates received from the multibank portal, and determining the interest rate structure of the trade period based on the interpolated value.

The interest rate difference of a currency pair is a difference between two interest rates of a currency pair on the basis of the interest rate of the base currency of the currency pair. When the currency pair is of the dollar and the yen, the interest rate difference of the currency pair is a value obtained by (interest rate of yen−interest rate of the dollar which is the base currency).

In S601, the interest rate structure determining part 304 performs following processing based on data obtained from the multibank portal 103 in S403. Specifically, the interest rate structure determining part 304 obtains interest rates of the currency pair (dollar/yen) specified in the selection field 512 on a specific due date (in each of two days, one week to three weeks, one month to 11 months, and one year after the present).

For example, the interest rate structure determining part 304 may obtain the interest rate difference from the spread by using following expression 7.

Interest rate difference=spread/spot price×365/period (expression 7)

Note that from expression 7 the spread is expressed by following expression 8 by using the interest rate difference.

Spread=spot price×interest rate difference×period/365 (expression 8)

If the interest rate difference is constant, the spread has a linear relation with the period. The period in expressions 7, 8 is the number of days (for example, seven days for one-week rate, 30 days for one month rate) from the foreign exchange trade date to the due date.

Further, when the multibank portal 103 transmits data including the interest rate of the dollar and the yen on a specific due date in S403, the interest rate structure determining part 304 may obtain the interest rate of the dollar and the interest rate of the yen from the transmitted data, and calculate the difference therebetween, so as to obtain the interest rate difference. When the multibank portal 103 transmits data including the interest rate difference information of the currency pair in S403, the interest rate structure determining part 304 may obtain the interest rate difference between the dollar and the yen from the transmitted data.

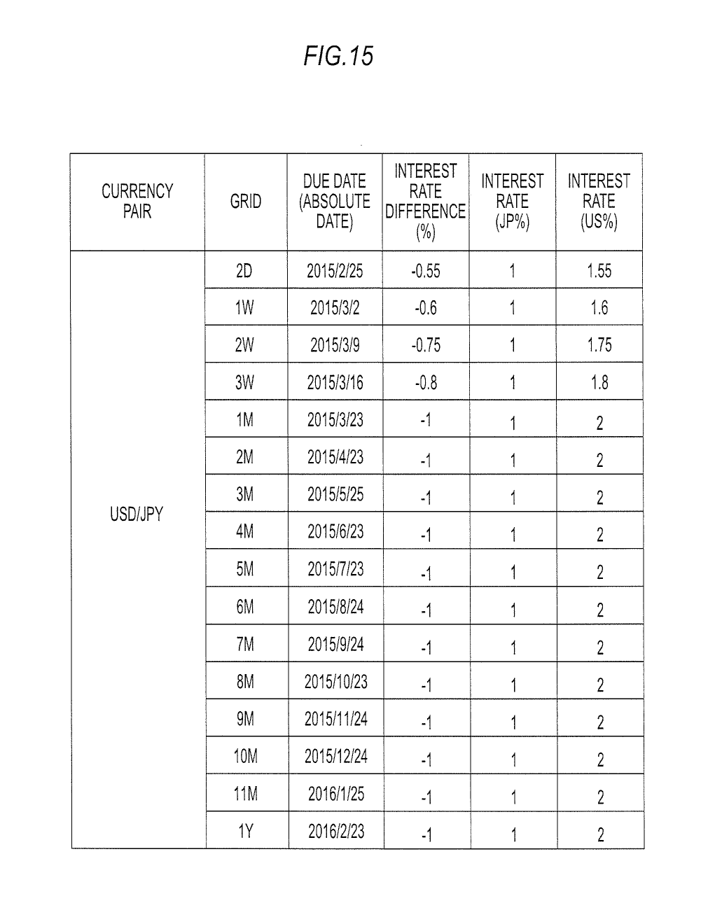

FIG. 15 is a diagram illustrating an example of interest rate on a specific due date obtained from the multibank portal 103. In S601, data obtained by the interest rate structure determining part 304 is data illustrated in FIG. 15. Differences of FIG. 15 from FIG. 9 will be explained.

“Interest rate difference (%)” of data of FIG. 15 indicates the interest rate difference of the dollar and the yen of the currency pair in percent. “Interest rate (JP %)” of data of FIG. 15 indicates the interest rate of the yen in percent. “Interest rate (US %)” of data of FIG. 15 indicates the interest rate of the dollar in percent.

In S602, the interest rate structure determining part 304 interpolates respective trade indexes of the currency pair of the first day and the last day of the trade period of the time option trade with the customer A based on the forward price obtained in S601.

A general expression for linearly interpolating the trade index which is the value of an interest rate difference on a certain due date×period/365 is as expressed by following expression 9.

Y=Y1+((Y2−Y1)(X−X1)/(X2−X1)) (expression 9)

In expression 9, Y is the currency index on a certain due date. X in expression 9 is the number of days from the day two days after the foreign exchange trade date to the due date corresponding to Y. Y1 in expression 9 is the trade index of the due date immediately before the due date corresponding to Y. X1 in expression 9 is the number of days from the day two days after the foreign exchange trade date to the due date corresponding to Y1.

Y2 in expression 9 is the trade index of the due date immediately after the due date corresponding to Y. X2 in expression 6 is the number of days from the day two days after the foreign exchange trade date to the due date corresponding to Y2.

The interest rate structure determining part 304 obtains X1, X2, Y1, Y2 based on the data transmitted in S403, and obtains X from the foreign exchange trade date and the first day or the last day of the trade period. The interest rate structure determining part 304 obtains the trade indexes of the first day or the last day of the period by using expression 9 based on obtained X, X1, X2, Y1, Y2.

In this embodiment, the interest rate structure determining part 304 interpolates the trade index of the first day, February 27 of the trade period by the trade index of February 25 (−0.55×0/365) and the trade index of March 2 (−0.6×5/365). The interest rate structure determining part 304 calculates the trade index of February 27 by using expression 9 with Y1=−0.55, Y2=−0.6, X=2, X1=0, X2=5. The calculated trade index of February 27 will be −0.55×0/365+(−0.6×5/365−(−0.55×0/365))*(2−0)/(5−0)≈−0.0033.

Further, the interest rate structure determining part 304 interpolates by similar processing the trade index of the last day, April 27 of the trade period by the trade index of April 23 and the trade index of May 23. The trade index of April 27 will be (−0.1×57/365)+((−0.1×87/365)−(−0.1×0.1×57/365))*(61−57)/(87−57)≈−0.1671.

In S603, the interest rate structure determining part 304 determines the interest rate structure of the trade period based on the trade indexes of the first day and the last day of the trade period interpolated in S602.

When the trade index of the first day of the trade period is equal to or more than the trade index of the last day of the trade period, the interest rate structure determining part 304 determines that the interest rate structure is discount because the value of the base currency decreases with passage of the period.

When the trade index of the first day of the trade period is smaller than the trade index of the last day of the trade period, the interest rate structure determining part 304 determines that the interest rate structure is premium because the value of the base currency increases with passage of the period.

In this embodiment, the trade index of February 27 is −0.0033 and the trade index of April 27 is −0.1671, the interest rate structure determining part 304, seeing that the trade index of the first day of the trade period is large, determines that the interest rate structure of the trade period as discount.

Through the above processing, the interest rate structure determining part 304 is able to determine the interest rate structure of a trade period even when only information of interest rates of a currency pair and a period can be obtained.

### Other Embodiments

The preferred embodiments of the present invention have been described above, but the present invention is not limited to such specific embodiments. For example, part or all of the functional configurations of the above-described trade processing system may be mounted as hardware in the management server 102.

Further, the trade indexes are not limited to those described in the above-described embodiments, and may be, for example, ones represented as estimated values of the trade indexes described in the above-described embodiments, or ones represented by modified calculation expressions.

The preferred embodiments of the present invention have been described above, but the present invention is not limited to such specific embodiments, and may be variously modified or changed within the range of the gist of the invention described in the claims.

According to the present invention, the forward price can be determined quickly.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A system comprising:
an obtaining unit obtaining a trade index of a currency pair on a set due date;
an interpolation unit interpolating trade indexes of a first day and a last day of a trade period in the time option trade based on the trade index obtained by the obtaining unit; and
a determining unit determining an interest rate structure of the trade period based on the trade indexes of the first day and the last day of the trade period interpolated by the interpolation unit.

2. The system according to claim 1,
wherein the determining unit determines, based on the trade indexes of the first day and the last day of the trade period which are interpolated by the interpolating unit, whether an interest rate structure of the trade period is a first interest rate structure which indicates that a value of a base currency of the currency pair decreases with passage of the period or a second interest rate structure which indicates that the value of the base currency of the currency pair increases with passage of the period.

3. The system according to claim 2, further comprising:
a first determining unit which determines, when the interest rate structure of the trade period is determined as the second interest rate structure by the determining unit, and the time option trade is a trade to sell the base currency of the currency pair to a counterparty, a last day of the trade period as a reference day for determining a forward price used for obtaining a trade price used in the time option trade, or determines, when the interest rate structure of the trade period is determined as the second interest rate structure by the determining unit, and the time option trade is a trade to buy the base currency of the currency pair from the counterparty, a first day of the trade period as the reference day; and
a second determining unit which determines the trade price based on the forward price of the reference day determined by the first determining unit.

4. The system according to claim 3, further comprising a storage unit which records cash management priority information indicating whether to give priority to cash management,
wherein the first determining unit determines the first day of the trade period as the reference day when the cash management priority information recorded in the storage unit indicates that cash management is given priority and the time option trade is a trade to sell the base currency of the currency pair to a counterparty, or determines the last day of the trade period as the reference day when the cash management priority information indicates that cash management is given priority and the time option trade is a trade to buy the base currency of the currency pair from the counterparty.

5. The system according to claim 3,
wherein the first determining unit determines the first day of the trade period as the reference day when the interest rate structure of the trade period is determined as the first interest rate structure by the determining unit and the time option trade is a trade to sell the base currency of the currency pair to a counterparty, or determines the last day of the trade period as the reference day when the interest rate structure of the trade period is determined as the first interest rate structure by the determining unit and the time option trade is a trade to buy the base currency of the currency pair to the counterparty.

6. The system according to claim 3, further comprising a cover deal ordering unit which, when details indicating that the time option trade is concluded is received, orders a cover deal of the time option trade based on the reference day determined by the first determining unit.

7. The system according to claim 3, further comprising:
a limit order accepting unit which accepts a limit order price of a leave order; and
a leave order concluding unit which concludes a trade at the limit order price when a difference between the tradable price and the limit order price accepted by the limit order accepting unit is smaller than a set threshold.

8. The system according to claim 2,
wherein the obtaining unit obtains, as the trade indexes of the currency pair on the due date, one of a spread of the currency pair on the due date, a forward price of the currency pair on the due date, and interest rate difference of the currency pair on the due date, and
wherein the determining unit determines that the interest rate structure of the trade period is the first interest rate structure when the trade index of the first day of the trade period interpolated by the interpolating unit is larger than the trade index of the last day of the trade period interpolated by the interpolating unit, or determines that the interest rate structure of the trade period is the second interest rate structure when the trade index of the first day of the trade period interpolated by the interpolating unit is smaller than the trade index of the last day of the trade period interpolated by the interpolating unit.

9. The system according to claim 1,
wherein the interpolating unit performs a linear interpolation of the trade indexes obtained by the obtaining unit, so as to interpolate the trade indexes of the first day and the last day of the trade period in the time option trade.

10. The system according to claim 1,
wherein the interpolating unit performs a polynomial equation interpolation of the trade indexes obtained by the obtaining unit, so as to interpolate the trade indexes of the first day and the last day of the trade period in the time option trade.

11. An information processing device, comprising:
an obtaining unit obtaining a trade index of a currency pair on a set due date;
an interpolation unit interpolating trade indexes of a first day and a last day of a trade period in the time option trade based on the trade index obtained by the obtaining unit; and
a determining unit determining an interest rate structure of the trade period based on the trade indexes of the first day and the last day of the trade period interpolated by the interpolation unit.

12. An information processing method executed by a system, the method comprising:
obtaining a trade index of a currency pair on a set due date;
interpolating trade indexes of a first day and a last day of a trade period in the time option trade based on the trade index obtained by the obtaining; and
determining an interest rate structure of the trade period based on the trade indexes of the first day and the last day of the trade period interpolated by the interpolation.

13. An trade processing method executed by an information processing device, the method comprising:
obtaining a trade index of a currency pair on a set due date;
interpolating trade indexes of a first day and a last day of a trade period in the time option trade based on the trade index obtained by the obtaining; and
determining an interest rate structure of the trade period based on the trade indexes of the first day and the last day of the trade period interpolated by the interpolation.

14. A non-transitory computer readable recording medium recording a program product for a computer to execute:
obtaining a trade index of a currency pair on a set due date;
interpolating trade indexes of a first day and a last day of a trade period in the time option trade based on the trade index obtained by the obtaining; and
determining an interest rate structure of the trade period based on the trade indexes of the first day and the last day of the trade period interpolated by the interpolation.
